(19) United States
(12) Patent Application Publication
(10) Pub. No.: US 2023/0247932 A1
(43) Pub. Date: Aug. 10, 2023

(54) SYSTEM AND METHOD FOR ON-PLANTER SEED TREATMENTS

(71) Applicant: Inflexion Point Technologies, LLC, Urbandale, IA (US)

(72) Inventors: Steven P. Smith, Ankeny, IA (US); Nicholas M. Iwig, Urbandale, IA (US); Stacy L Unruh, Haben, KS (US); Nathen K. Deppe, Kellogg, IA (US)

(73) Assignee: Inflexion Point Technologies, LLC, Urbandale, IA (US)

(21) Appl. No.: 18/003,108

(22) PCT Filed: Jun. 25, 2021
(86) PCT No.: PCT/US21/39170

§ 371 Date: Dec. 22, 2022

Related U.S. Application Data
(60) Provisional application No. 63/045,092, filed on Jun. 27, 2020.

(51) Int. Cl. A01C 1/06; A01C 7/06; A01C 7/10; A01C 7/20; A01C 21/00

(52) U.S. Cl. CPC A01C 1/06; A01C 7/06; A01C 7/105; A01C 7/206; A01C 21/005

(57) ABSTRACT

A system and method for on-planter seed treatments is disclosed. The planter includes a seed meter, a seed drop tube, a seed, a seed-applied substance receptacle, and a seed-applied substance applicator having a discharge path. A seed-applied substance is loaded in the seed-applied substance receptacle. The seed-applied substance is supplied to the seed-applied substance applicator. The seed-applied substance is discharged from the seed-applied substance applicator into the discharge path during planting. The seed from the seed drop tube is combined with the seed-applied substance from the seed-applied substance applicator within the discharge path for prescriptively treating the seed with the seed applied substance. The seed having on it the seed applied substance is then planted.

### CROSS-REFERENCE TO RELATED APPLICATIONS

This application claims priority under 35 U.S.C. § 119 to provisional application Ser. No. 63/045,092 filed on Jun. 27, 2020, which is incorporated by reference in its entirety.

### FIELD OF THE DISCLOSURE

The present disclosure relates generally to the application of seed treatments directly onto seed during planting. More particularly, but not exclusively, the present disclosure relates to a system and method for on-planter seed treatments.

### BACKGROUND

Applying seed treatments to seed at a time other than at the time of planting limits the effectiveness of prescriptively treating seed in a manner that accounts for a myriad of conditions, such as the needs that exist for a particular planting, in a particular field, with a particular seed, and under particular conditions. Therefore, what is needed is a system and method for on-planter seed treatments.

### SUMMARY

Therefore, it is a primary object, feature, and/or advantage of the present disclosure to improve on the state of the art and overcome the deficiencies within the art.

It is also a primary object, feature and/or advantage of the present disclosure to provide a system and method for prescriptively treating seed immediately before the seed is planted in the furrow by applying one or more seed-applied substances.

In at least one aspect of the present disclosure, a method for on-planter seed treatments is disclosed. The method includes, for example, a planter having a seed drop tube, a seed drop tube outlet, a seed, a seed-applied substance receptacle, and a seed-applied substance applicator having a discharge path. The method for on-planter seed treatments can include, such steps as, loading a seed-applied substance in the seed-applied substance receptacle, introducing the seed-applied substance at the seed-applied substance applicator, discharging the seed-applied substance from the seed-applied substance applicator into the discharge path oriented to cover at least the portion of the seed travel path at the seed drop tube, combining the seed from the seed drop tube with the seed-applied substance from the seed-applied substance applicator within the discharge path, and planting the seed having on it the seed-applied substance.

In at least another aspect of the present disclosure, a microscale application system for on-planter seed treatments is disclosed. The microscale application system includes, for example, a planter having a plurality of row units, each row unit having a seed drop tube for planting a seed in the ground. A seed-applied substance receptacle can be configured to house a seed-applied substance. A seed-applied substance applicator can be disposed at the seed drop tube. The low-pressure seed-applied substance applicator can have a microscale nozzle configured to discharge a microscale quantity of the seed-applied substance into a discharge path. A flow path can be configured between the seed-applied substance receptacle and the seed-applied substance applicator and a controller can be connected to the seed-applied substance applicator for controlling the discharge of the seed-applied substance into the discharge path.

In at least one other aspect of the present disclosure, a method for on-planter seed treatments is disclosed. The method includes, for example, a planter having a plurality of row units, each row unit having a seed drop tube with a seed drop tube outlet for planting a seed in the ground, a seed-applied substance receptacle, a seed-applied substance applicator having a seed-applied substance nozzle for discharging the seed-applied substance, a discharge path for the seed-applied substance, and a controller. The method for on-planter seed treatments can include, such steps as, singulating the seed, selecting the seed-applied substance based on a location of the planter in a field, communicating the selected seed-applied substance from the seed-applied substance receptacle to the seed-applied substance nozzle, and discharging the seed-applied substance into the discharge path. The discharge path can be disposed at the seed drop tube and the seed-applied substance can be configured to occupy the discharge path at least when the singulated seed is within the discharge path.

In an aspect of the present disclosure, a method for on-planter seed treatments is disclosed. The method includes, for example, a planter having a seed meter, a seed drop tube, a seed, a seed-applied substance receptacle(s), and a seed-applied substance applicator having a discharge path. The method for on-planter seed treatments can include, such steps as, loading a seed-applied substance in the seed-applied substance receptacle, introducing the seed-applied substance at the seed-applied substance applicator, discharging the seed-applied substance from the seed-applied substance applicator into the discharge path, combining the seed from the seed drop tube with the seed-applied substance from the seed-applied substance applicator within the discharge path, and planting the seed having on it the seed-applied substance.

In another aspect of the present disclosure, a system for on-planter seed treatments is disclosed. The system includes, for example, a planter having one or a plurality of row units. Each row unit can have a seed meter and seed drop tube for planting a seed in the ground. One or more seed-applied substance receptacle(s) can be configured, on the planter in at least one example, to house a seed-applied substance. Seed-applied substance applicator(s) can be disposed at the seed drop tube. Seed-applied substance applicator(s) can have a nozzle configured to discharge the seed-applied substance into a discharge path. A flow path can be configured between the seed-applied substance receptacle and the seed-applied substance applicator, such as, for communicating the seed-applied substance to the seed-applied substance applicator. In one aspect, a controller is operably connected to the seed-applied substance applicator for controlling the discharge of the seed-applied substance.

In yet another aspect of the present disclosure, a method for on-planter seed treatments is disclosed. The method includes, for example, a planter having one or more row units, each row unit having a seed meter, a seed drop tube for planting a seed in the ground, a seed-applied substance receptacle, a seed-applied substance applicator disposed at the seed drop tube, a discharge path for the seed-applied substance, and a controller. The method for on-planter seed treatments can include such steps as selecting one or more types of seed-applied substances based on the location of the planter in a field using the controller, detecting or calculating the presence of the seed in the seed drop tube, and discharging the selected seed-applied substance from the seed-applied substance applicator based on a time of detecting the seed or calculating the location of the seed.

One or more of these and/or other objects, features, or advantages of the present disclosure will become apparent from the specification and claims that follow. No single aspect of the disclosure need provide each and every object, feature, or advantage. Different aspects of the disclosure may have different objects, features, or advantages. Therefore, the present disclosure is not to be limited to or by any objects, features, or advantages stated herein.

### BRIEF DESCRIPTION OF THE DRAWINGS

Illustrated embodiments of the disclosure are described in detail below with reference to the attached drawing figures, which are incorporated by reference herein, and where:

FIG. 1 is a view of a planter in accordance with an illustrative aspect;

FIG. 2 is a view of a row unit in accordance with an illustrative aspect;

FIG. 3 is a view of a main controller in accordance with an illustrative aspect;

FIG. 4 is a view of a seed-applied substance applicator in accordance with an illustrative aspect;

FIG. 5 is a view of a seed drop tube, a valve and a nozzle in accordance with an illustrative aspect;

FIG. 6 is a block diagram providing a pictorial representation of an on-planter seed treatment system in accordance with an illustrative aspect;

FIG. 7 is a block diagram providing a pictorial representation of a control system for on-planter seed treatments in accordance with an illustrative aspect;

FIG. 8 is a flowchart providing a pictorial representation of an on-planter seed treatment method in accordance with an illustrative aspect; and

FIG. 9 is a flowchart providing another pictorial representation of an on-planter seed treatment method in accordance with an illustrative aspect.

### DETAILED DESCRIPTION

The present disclosure contemplates many different methods and systems for on-planter seed treatments. Representative applications of methods and systems are described in this section. These examples are being provided solely to add context and aid in the understanding of the described aspects of the disclosure. It will thus be apparent to one skilled in the art that the described aspects of the disclosure may be practiced without some and/or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and show, by way of illustration, specific embodiments in accordance with the methods and systems of the present disclosure. Although aspects of the disclosure are described in sufficient detail to enable one skilled in the art to practice the described embodiments, it is understood that these examples are not limiting; other aspects may be used, and changes may be made without departing from the spirit and scope of the described aspects of the disclosure.

It will also be understood that, although the terms first, second, etc. may be used herein to describe various elements, these elements should not be limited by such terms. These terms are only used to distinguish one element from another. For example, a first step could be termed a second step, and, similarly, a second step could be termed a first step, without departing from the spirit and scope of the present disclosure.

The terminology used herein is for the purpose of describing particular aspects of the disclosure only and is not intended to be limiting of the present disclosure. As used in the description of the invention and the appended claims, the singular forms “a”, “an” and “the” are intended to include the plural forms as well, unless the context clearly indicates otherwise. By way of example only, while the singular form of numerous components and steps are described in various aspects of the disclosure herein, it will be apparent that more than one of such components and/or steps can be used to accomplish the same. It will also be understood that the term “and/or” as used herein refers to and encompasses any and all possible combinations of one or more of the associated listed items. It will be further understood that the terms “comprises” and/or “comprising,” when used in this specification, specify the presence of stated features, functions, integers, steps, operations, elements, and/or components, but do not preclude the presence and/or addition of one or more other features, integers, steps, operations, elements, components, and/or groups thereof. It will be similarly understood that the terms “including,” “include,” “includes”, “such as” and the like, when used in this specification, are intended to be exemplary and should be construed as including, but not be limited to, all items recited thereafter. As used herein, the term “if” may be construed to mean “when” or “upon” or “in response to determining” or “in response to detecting,” depending on the context.

As used herein, the term “planter” includes equipment, devices and other planter implement systems and/or technology used in planting operations. For example, the present disclosure contemplates that planters can include past planters, currently existing planters, future planters and other current and future equipment used in the planting process, including, but not be limited to, tractors, cabins, nurse tanks, and bulk input devices. The various features of the disclosure are useful in connection with any device used in planting one or more seeds (e.g., broadcast planters, drill planters, air planters, bulk planters, individual row unit planters, research planters, clam-shell planters, cone planters, cyclone planters, pneumatic planters, finger planters, plate planters, and the like), especially those devices that could be used to plant one or more combinations of seeds and seed-applied substances that are prescriptively selected for planting at one or more locations.

As used herein, the term “seed” includes seeds of any type of plants, including, but not be limited to, row crops, cereals, grains, oilseeds, fruits, vegetables, turf, forage, ornamental, nuts, tobacco, plantation crops and the like (including, without limitation, cotton and other fiber and hemp and related seeds).

As used herein, the terms “substance” and/or “seed-applied substance” include any composition applied to seeds prior to the seeds being planted (e.g., when the seed comes in contact with the soil in a field). The seed-applied substance(s) can include active ingredients, other substances, combinations of more than one active ingredient and/or other substances, and/or mixtures having one or more active ingredients and/or one or more other substances. The active ingredients can include any type of substance that causes something to occur (for example, the ingredient(s) in a pesticide that impact the pest, the ingredients in a fungicide that impact the disease and/or plant growth, health and/or vigor, the ingredients in a nematicide that impact the nematode, the ingredients in an inoculant and/or other plant growth and/or health substance that cause the plant to improve its growth, health and/or vigor). The active ingredients can include any past, present and/or future active ingredients and can be chemicals, biologicals (including, without limitation, fungal, bacterial, parasitic, insects and other living organisms), biostimulants, micronutrients, and/or other compositions. Examples of some current potential active ingredients include nitrogen, clothianidin, ipconazole, trifloxystrobin, imidacloprid, metalaxyl, pyraclostrobin, bradyrhizobium, myclobutanil, thiamethoxam, abamectin, mefonoxam, fludioxonil, fipronil, azoxystrobin, cyantraniliprole, Rynaxypyr®, and the like. The other substances typically do not impact the target (for example pest, disease, nematode and/or plant growth, health and/or vigor), but can be helpful to include for a variety of reasons, including, but not be limited to, causing the active ingredients to be at the appropriate levels and/or concentrations to be efficacious but not harmful to the seed and/or plant, helping the active ingredient affix and/or stick to the seed, helping the treated seeds not stick to each other and/or other objects, improving the color of the treated seed (e.g., to indicate the seed is treated with a pesticide), increasing the number and/or amount of active ingredients a seed can absorb and/or otherwise carry and the like. Examples of some of these other substances include polymers, pigments, binders, surfactants, colorants, coatings, and other additives. The seed-applied substances can take any form, including, but not be limited to, wet and dry substances.

As used herein, the term “combination” includes one or more types and/or one or more amounts of seed-applied substances that are applied to a seed.

As used herein, the term “farmer” includes farmers, farm owners, farm managers, farm investors, farmer operators, seed companies, planter companies, chemical companies, biological companies, agricultural research companies and/or any other individual and/or entity that can engage in farm-related decisions and/or activities.

As used herein, the term “condition(s)” includes any circumstance that can impact what seed to be planted at a particular location and/or the type and/or amount of seed-applied substance(s) applied to such seed. In some aspects of the disclosure, these conditions can include historical conditions, current conditions, future and/or predictive conditions and the like. By way of example, historical conditions can include past pests, insects, parasites, and/or diseases (e.g., rootworms, cutworms, aphids, nematodes, white mold, fungus), pest pressures, soil types, weather conditions, water levels, soil conditions (e.g., last-known nutrient, fertility, temperature and/or moisture levels of the soil), weeds, weed pressures, knowledge of the terrain of the field, and/or planting practices and/or associated yields. By way of further example, current conditions can include current pest type and/or levels, pest pressure, soil type, weather conditions, planting date, water levels, soil conditions, weed levels, weed type, weed pressure, field terrain of the field, global positioning system (GPS) coordinates, geographical location of the system, geographical location, other location-based conditions, seed availability, nearby pest pressures and/or trends, commodity pricing and/or other market conditions, planter gas level, planter engine and/or ground speed and/or other planting operational monitoring information. By way of still further example, future conditions can include weather forecasts and/or predictions, projected planting date, projected yield of seeds, and/or predicted commodity pricing and/or other market conditions. Additionally, the conditions can be based, at least in part, on historical measurements, real-time measurements, predicative measurements, analytics and/or the like.

In one aspect, the present disclosure sets forth microscale methods and systems for on-planter seed treatments and is better understood by contrasting microscale with macroscale application processes, like that of in-furrow applications. It is important to note that macroscale application processes, like in-furrow applications, use bigger tubing, larger applicators, longer dispense times and volumes (e.g., milliliters), larger valves, higher volume pumps, and other macroscale components often to create a pool of the material in the furrow to ensure enough remains in the soil when the seed actually hits the furrow. This application inefficiency results in over application (i.e., overage), low-precision application, longer application times, and so forth. In addition to the material waste and high cost of goods sold resulting from in-furrow applications, seed can be damaged when too much of certain active ingredients contact seed. Conversely, microscale treatments involve smaller tubing, smaller applicators, shorter dispense times and volumes (e.g., nanoliters), smaller valves, lower volume pumps, and other microscale components to create a mist or fog or other dispersions for applying to the seed. Seed treatment material losses are minimized due to precision application (i.e., minimal to very little overage), even if there's overage it represents a smaller volumetric amount compared to macroscale overage, high precision and more direct application, short application times, less cost, and so forth. The potential for seed damage is greatly reduced if not eliminated with microscale treatments.

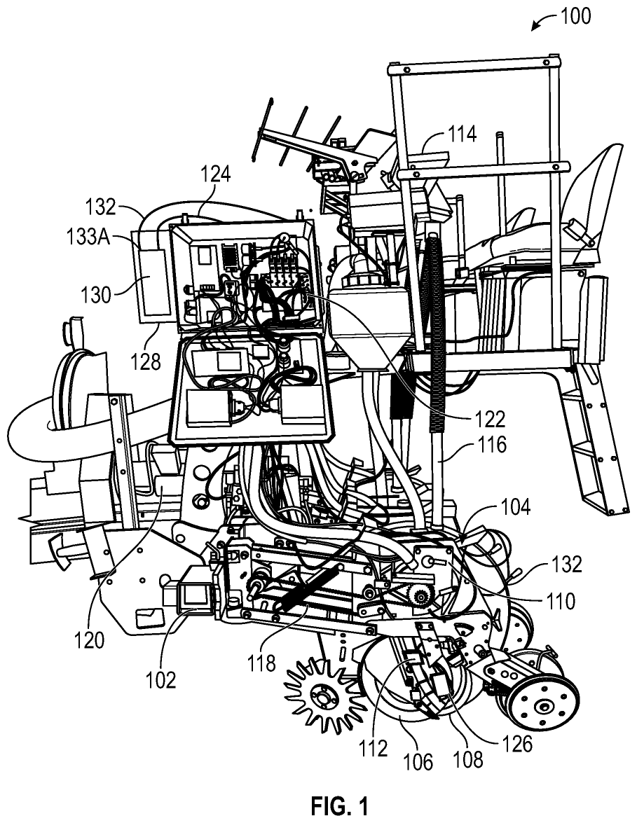

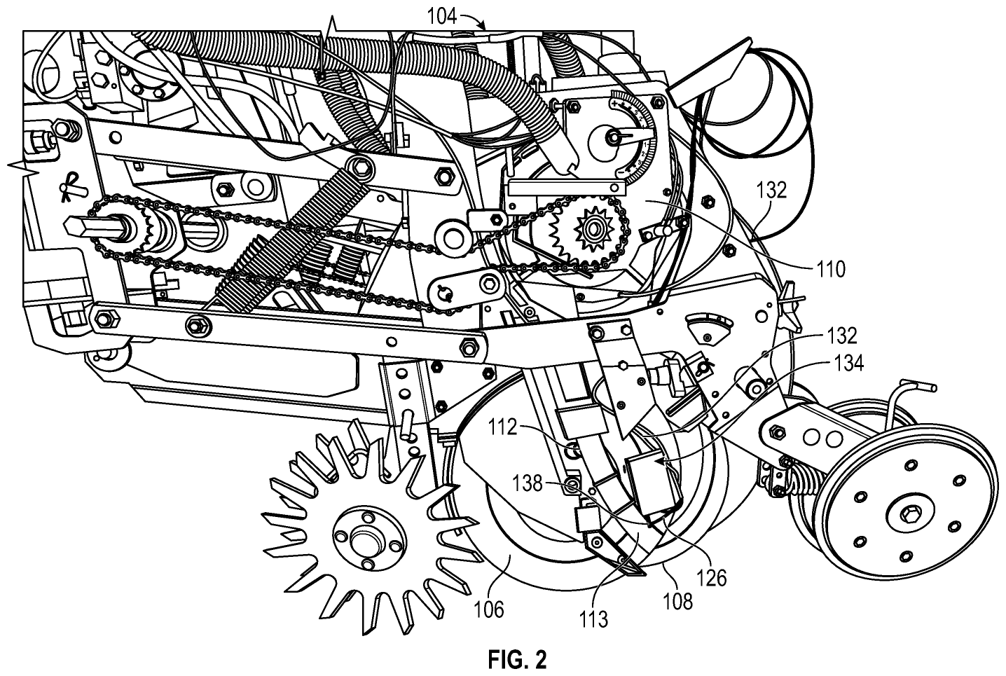

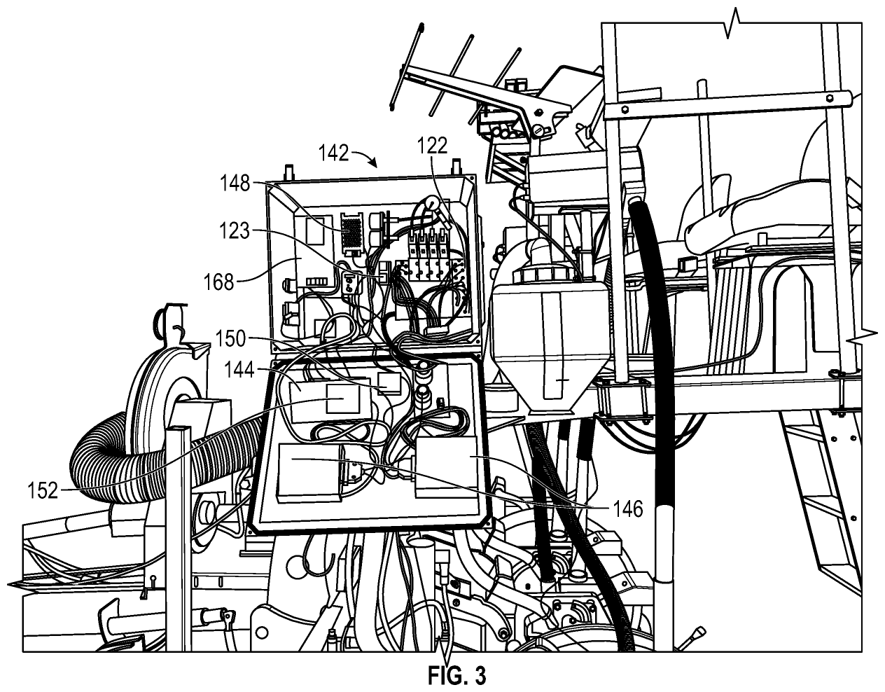

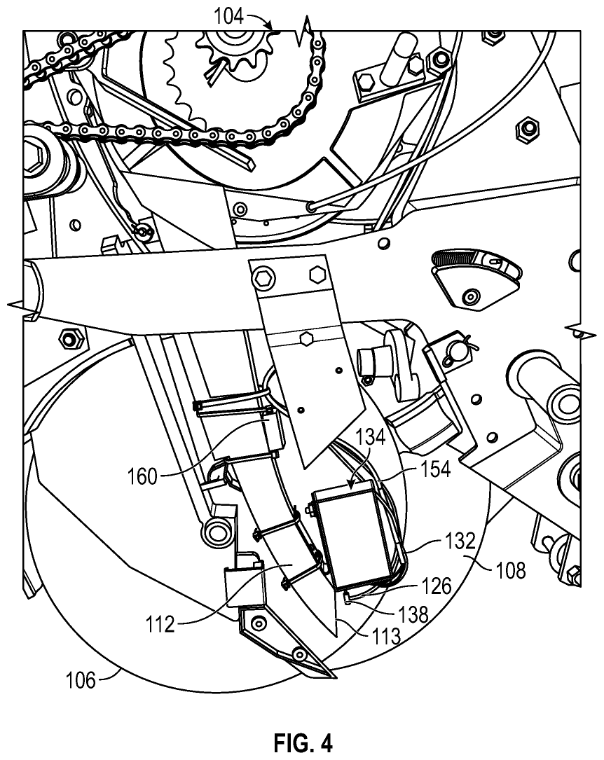

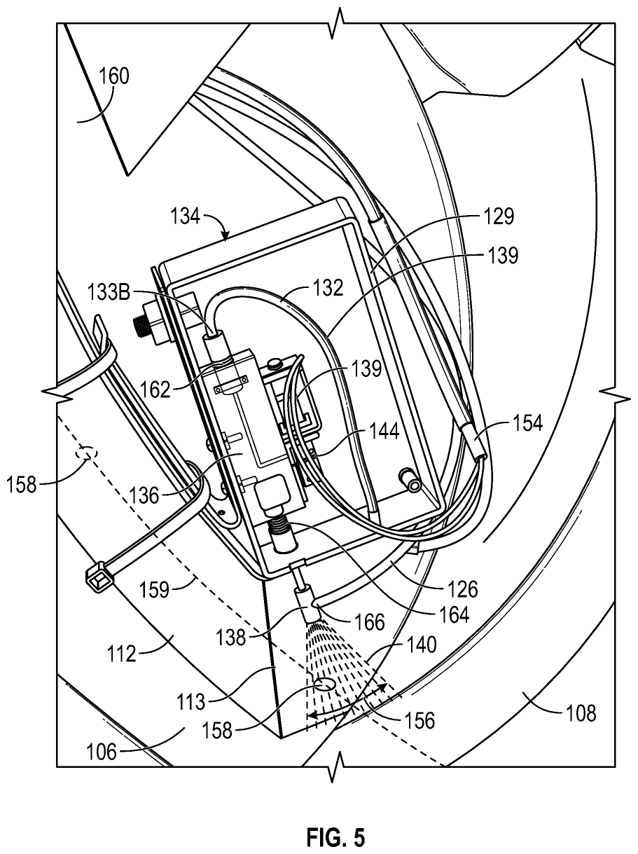

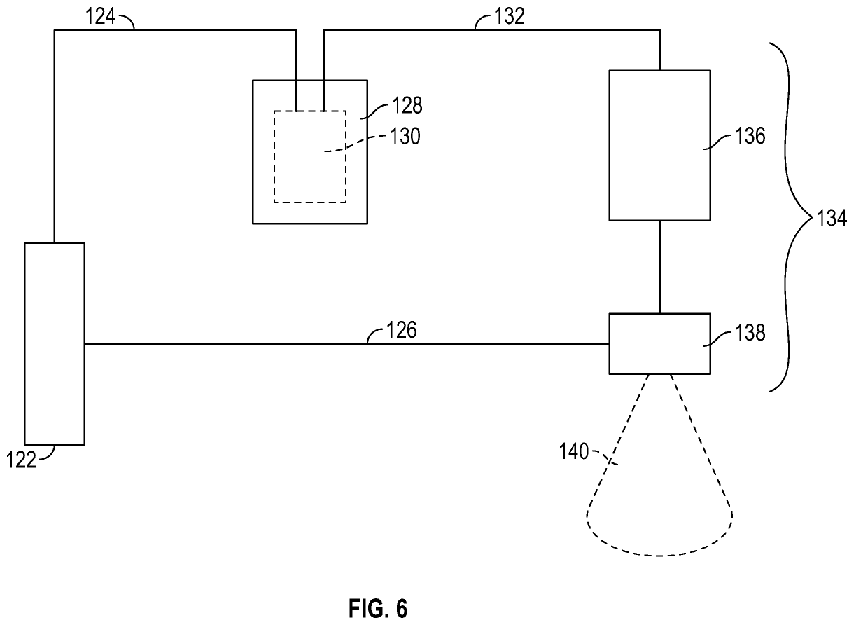

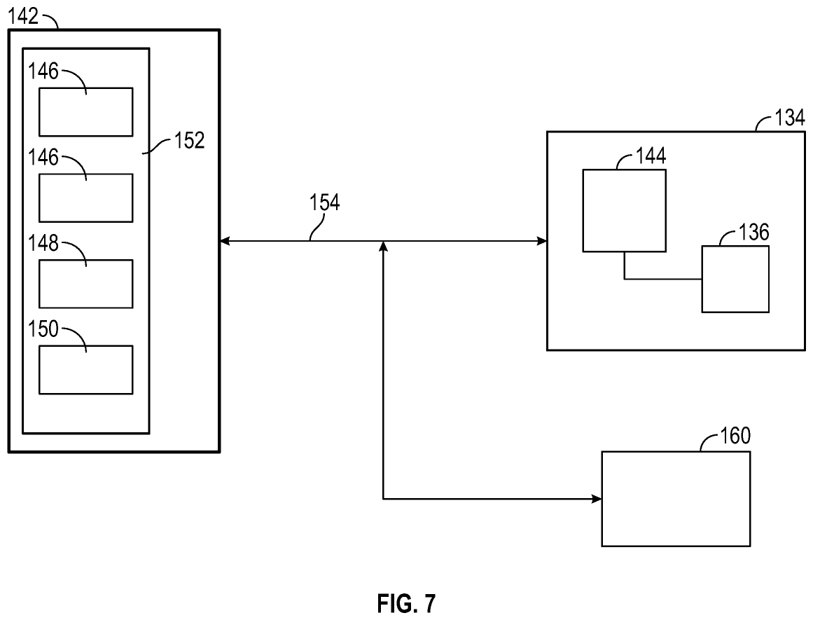

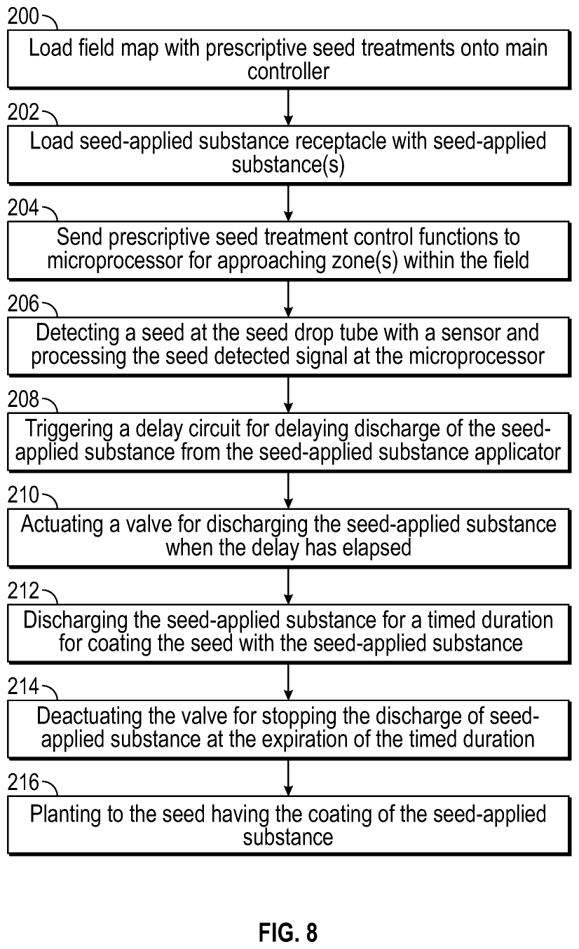

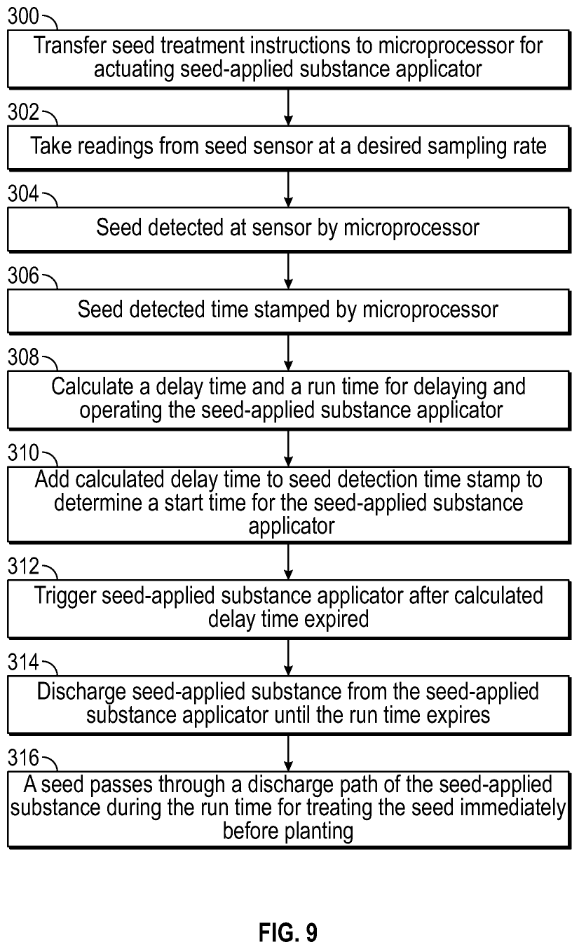

FIGS. 1-9 illustrate various aspects of methods and systems for on-planter seed treatments. The figures illustrate exemplary agricultural equipment systems with which the objects of the present disclosure can be implemented. The agricultural equipment can be comprised of a planter implement 100. The planter 100, as previously defined, can include a tractor (not shown) that can be operably connected to a draw bar that can be operably connected to a frame 102, which can be comprised of any type, number and/or configuration of structural members to support the components of the planter 100, including, but not be limited to, one or more individual row units 104.

Row units 104 can include, amongst other hardware, an opening disc 106 for opening a furrow in the ground and a closing wheel 108 for closing the furrow overtop of a seed 158. Each row unit 104 can include a seed meter 110 configured to meter seed 158 from a seed hopper 114 into a seed drop tube 112 by actuation using a seed meter drive mechanism 118. Seed 158 from the seed hopper 114 can be provided to the seed meter 110 through a seed tube 116. A seed drive mechanism 118 can control the rate of operation of the seed meter 110 and the planting rate or the rate at which seed 158 is being delivered through seed drop tube 112 into the soil for planting.

Planter 100 can also include a compressor 120 for generating pressurized air and an air tank (not shown) for storing the pressurized air. An air manifold 122 can be operably connected to receive pressurized air from the compressor 120 and/or air tank. One or more pressure reducers (not shown) may be operably connected to the air manifold 122 or compressor 120 for reducing the pressure of the air to a lower psi/bar for different air pressures, or conversely vacuum, required functions and applications of planter 100.

Planter 100 can also include a seed-applied substance receptacle 128 configured for removably housing a seed-applied substance 130. Seed-applied substance 130 preferably has a low viscosity, with viscosities between 1-20 centipoise being most preferred. The viscosity of seed-applied substance 130 can be below 1 centipoise and above 20 centipoise. In some instances, where viscosity is above 20 centipoise, an additive can be used to lower the viscosity of the seed-applied substance 130 to within the preferred range or a carrier can be used. Planter 100 can be configured with any number of seed-applied substance receptacles 128 for housing a variety of seed-applied substances 130 for providing a variety of treatments to seed 158.

In at least one aspect, an air flow path 124 can be operably connected to the air manifold 122 for providing pressurized air to the seed-applied substance receptacle 128 for applying a pressure to the seed-applied substance 130. In at least one configuration, the pressure applied to the seed-applied substance 130 preferably is less than 1 bar or ˜14 psi. In another aspect, the pressure can be less than ½ bar or ˜7 psi. Pressures in excess of 1 bar or 14 psi can be used; however, lower pressures are preferred and generally only needed for operating seed-applied substance applicator 134. The volume of air can vary based on a wide range of factors, including, at least in part, a number of seed-applied substance applicators 134, nozzles 138, or valves 136. A pressure regulator 123 can be operably connected to the air flow path 124 or air manifold 122 for controlling the pressure of the air in air flow path 124 and in seed-applied substance receptacle 128. Planter 100 can be configured with any number of air flow paths 124 that can be operably connected to a single air manifold or multiple air manifolds 122 for providing pressurized air to a plurality of seed-applied substance receptacles 128 for providing a variety of treatments to seed 158.

Seed-applied substance receptacle 128 can include a seed-applied substance flow path 132 through which pressurized seed-applied substance 130 exits the seed-applied substance receptacle 128. Flow of the seed-applied substance can be by positive (i.e., plenum or pressure greater than atmospheric) pressure or negative (i.e., vacuum or pressure less than atmospheric) pressure. The seed-applied substance flow path 132, in at least one configuration, has a first end 133A operably connected to the seed-applied substance receptacle 128 and a second end 133B operably connected to a seed-applied substance applicator 134. Planter 100 can be configured with any number of seed-applied substance flow paths 132 operably connected to a plurality of seed-applied substance receptacles 128 for providing a variety of prescriptive treatments to seed 158.

A seed-applied substance applicator 134 can be operably configured at each or one or more of the row units 104. The present disclosure contemplates locating the seed-applied substance applicator 134, in at least one configuration, in a location that is generally protected from disruptive elements present within a field during planting. Often wind, dust, field objects, dirt, airborne materials, liquids (e.g., rain or other field moisture) can impact the precision and operation of a seed-applied substance applicator 134. In a preferred aspect, seed-applied substance applicator 134 is protectively disposed at the seed drop tube 112 between opposing opening discs 106 and closing wheels 108. Other aspects of the present disclosure contemplate the seed-applied substance applicator 134 being disposed at other positions, including, without limitation, any position at the seed drop tube 112 and other locations where the seed-applied substance applicator 134 can be configured to apply the seed-applied substance 130 to the seed, post-singulation of the seed 158, as or after it is dropping out of the seed drop tube 112. In a preferred aspect, seed-applied substance applicator 134 can be disposed at the seed drop tube outlet 113.

Seed-applied substance applicator 134 can include a housing 129 for protecting components and operation of the seed-applied substance applicator 134. In at least one aspect, seed-applied substance applicator includes a seed-applied substance valve 136, preferably electronically controlled, with an electronic solenoid 139. In one aspect of the disclosure, seed-applied substance valve 136 comprises a piezoelectric valve, such as the commercially available piezo valve from Festo Corporation (www.festo.com). Valve 136 can include a seed-applied substance input 162 operably connected to the second end 133B of the seed-applied substance flow path 132 for receiving pressurized seed-applied substance 130 from the seed-applied substance receptacle 128. Valve 136 preferably has an open position for allowing seed-applied substance 130 to pass through a seed-applied substance output 164 that can be operably connected to a seed-applied substance nozzle 138. Valve 136 preferably has a closed position for prohibiting seed-applied substance 130 from passing through the seed-applied substance output 164.

In a preferred aspect, valve opening and closing is controlled using a microprocessor 144. Microprocessor 144 can be operably connected to solenoid 139 for providing an electrical charge to valve for opening the valve 136. A wiring harness 154 can be operably connected to microprocessor 144 and solenoid 139. Wiring harness can also be operably connected to a main controller 142. Main controller 142 can be configured to control microprocessor 144, which in turn can control valve 136. The main controller 142 can be configured to operate control valve 136 independent of a microprocessor. In at least one configuration, microprocessor 144 is disposed within housing 129 proximate valve 136. Inputs from the main controller 142 for controlling the microprocessor 14 can be sent from the main controller 142 to the microprocessor 144 in advance for controlling operation of the valve 136 for current zones being traversed and approaching zones within a field. While many different configurations of the microprocessor 144 and main controller 142 are contemplated, in one preferred aspect, one or more microprocessor(s) 144 can be located somewhere on a row unit 104 (preferably proximate to one or more seed-applied substance applicators 134 or valves 136) and one or more main controllers 144 can be disposed elsewhere, including, without limitation, proximate to one or more seed-applied substance receptacles 128, proximate to the frame 102, elsewhere on the planter 100 or on the tractor (not shown).

In at least one configuration, seed-applied substance applicator 134 can include a seed-applied substance nozzle 138 operably plumbed to seed-applied substance output 164 of valve 136. In at least one aspect, nozzle 138 can have a microscale size nozzle, which preferably has an orifice diameter between 0.025 and 0.075 inches. Other nozzle diameters are contemplated. Nozzle diameter is preferably based on a low-pressure seed-applied substance 130 being fed through the nozzle diameter and viscosity of the seed-applied substance 130. Too large of a nozzle 138 may result in failing to properly atomize the seed-applied substance 130 at lower pressures and when using higher viscosity seed-applied substances 130. As a result, the amount of seed-applied substance 130 that is applied to the seed 158 may exceed the desired volume when using too large of nozzle 138. For example, using too large of a nozzle 138 may result in applying more seed-applied substance 130 than the label rate range of the amount of an active ingredient currently used for traditional bulk pre-treatment of seeds 158 and/or excessive amounts of waste (e.g., the total amount of seed-applied substance 130 that is discharged into the seed-applied substance discharge path 140 that is not applied to the seed 158). Alternatively, too small of nozzle 138 can result in some seed-applied substances 130 with higher viscosities clogging the nozzle and/or the amount of seed-applied substance 130 that is discharged onto the seed not meeting the desired range (e.g., volume of seed-applied substance 130). Nozzle 138 preferably includes an air input 166 operably connected to air manifold 122 via air flow path 126. In such configurations, pressurized air can be provided to nozzle 138 generally at ½ bar (˜7 psi). The pressure may be increased or decreased depending upon many factors, including, without limitation, the viscosity of seed-applied substance 130, the diameter and length of seed-applied substance flow path 132, and the diameter of the orifice of the seed-applied substance nozzle 138. For example, pressure ranges in combination with a range of nozzle sizes, viscosities and other relevant factors are contemplated. Viscosity ranges of 1-20 centipoise can perform operably at ½ bar (˜7 psi) pressure. Other nozzle 138 configurations and operating pressures for various seed-applied substances 130 of various viscosities are contemplated by the present disclosure. Nozzle 138 can be an atomizing nozzle in at least one preferred aspect of the disclosure whereby pressurized air from air manifold 122 can atomize the seed-applied substance 130 upon discharge, and atomized seed-applied substance 130 can discharge from nozzle 138 in a seed-applied substance discharge path 140. In one preferred aspect, discharge path is generally conical in shape. Alternatively, the discharge path 140 can have any shape that enables a high percentage of seed 158 to flow through it, including, but not limited to, a fan shape, flat fan shape, full or hollow cone shape, extra wide angle, full cone square shape, spiral cone shape, or any other suitable shape. While various nozzle angles are contemplated, in at least one configuration, the range of optimal nozzle angles could be determined by key factors, including, without limitation, the angle of the seed drop tube outlet 113 and the size of the discharge path, in an effort to maximize the likelihood that seed 158 passes through the seed-applied substance discharge path 140 during descent of the seed 158 after exiting seed drop tube 112 and traveling along the seed travel path 159. In at least one configuration, nozzle 138 has a nozzle angle 156 ranging from 10-15 degrees, 15-20 degrees, or 20-25 degrees. Other nozzle angles are contemplated. While many nozzle 138 configurations are considered, nozzle 138 is preferably disposed in a manner whereby seed-applied substance discharge path 140 occupies the airspace immediate or nearly immediate to the seed drop tube outlet 113 where seed 158 is most likely to exit the seed drop tube 112. In some of such configurations, nozzle 138 can be disposed proximate or along the seed drop tube 112 and/or seed drop tube outlet 113. Nozzle 138 is preferably angled to intercept the seed 158 in the seed travel path 159, preferably immediately, if not nearly immediately, outside of the seed drop tube outlet 113. In other configurations, seed-applied substance nozzle 138 can be disposed at a position along the seed drop tube 112 to emit the seed-applied substance 130 into discharge path 140 at one or more locations along the length of the seed drop tube 112. In one configuration, the nozzle 138 can be operably disposed within the seed drop tube 112 and angled whereby the seed applied substance is directed toward the seed travel path 159 and the seed drop tube outlet 113. In at least one configuration, the seed-applied substance discharge path 140 can have at least one side that is generally parallel with the seed drop tube outlet 113. The seed-applied substance discharge path 140 is also preferably configured to cover the maximum amount of space that includes the seed travel path 159 immediately outside the seed drop tube outlet 113 so that the seed 158 exits the seed drop tube 112 into the seed-applied substance discharge path 140. Current commercial seed drop tubes commonly include a seed drop tube outlet 113 that is angled downward. The downward orientation of the seed drop tube 112 and the downward angle of the seed drop tube outlet 113 often causes the vast majority of seeds 158 to exit the seed drop tube 112 generally at the bottom portion of the seed drop tube outlet 113. As such, the present disclosure contemplates, in at least one configuration nozzle 138 being located closer to the bottom of the seed drop tube outlet 113 thereby allowing the seed-applied substance discharge path 140 to be generally smaller while still acceptably increasing the likelihood that most seeds will pass through the discharge path 140.

To increase the likelihood that the general entirety of the seed-applied substance discharge path 140 includes seed-applied substance 130 at the time of the seed 158 passing through it, the disclosure contemplates, in at least one aspect, that main controller 142 and/or microprocessor 144 can adjust various parameters about the dispense time, including, but not limited to, the duration of time seed-applied substance 130 is dispensed (i.e., dispense time), for example, relative to the position of the seed 158 in the seed travel path 159, the interval of time between seed detection and when the seed-applied substance applicator 134 is actuated on (i.e., delay time), for example, relative to the position of the seed 158 in the seed travel path 159, and the conditions within the field at the time of planting, for example, wind or other environmental factors that might alter the dispense time, delay time, or other factors relating to seed-applied substance 130 being in the seed-applied substance discharge path for the seed 158 to pass through on its descent through the seed travel path 159. In some configurations, the seed-applied substance nozzle 138 can also be generally directed downward to follow the downward trajectory of the seed 158 traveling through the seed travel path 159 into the furrow. The general downward discharge of the seed-applied substance 130 can also help keep the seed-applied substance 130 from accumulating on the bottom end of the seed drop tube outlet 113 or otherwise in the seed drop tube 112.

Planter 100 can include a number of row units 104. Each row unit 104 can include a seed meter 110 and seed drop tube 112. In one configuration of the present disclosure, seed drop tube can include a seed sensor 160 to detect seed 158 dispensed from seed meter 110 during planting. Seed sensor 160 is preferably an optical sensor, such as an LED sensor. In one aspect, sensor 160 can be a commercial sensor, such as, The Hy Rate Plus™ LED Seed Sensor from Dickey-John (www.dickey-john.com). The seed sensor 160 can be configured to monitor seed drops at seeding rates between 1-135 seeds/sec across multiple seed types. Seed sensor 160 can be operably connected via wiring harness 154, or alternatively wirelessly, to microprocessor 144 at seed-applied substance applicator 134 and main controller 142. The seed drop tube 112 can include one or more sensors 160 disposed at one or more locations along the seed drop tube 112 for detecting seed 158. In at least one configuration, the seed sensor 160 can have a field of view (i.e., sensor zone) within the seed drop tube 112 generally 0.5 inches tall and 0.75 inches wide. Microprocessor 144 can be configured to sample the sensor zone at varying rates. In at least one aspect, sampling can be done at a rate whereby the microprocessor 144 receives 32,000 signals during the time it takes for the seed to pass through the sensor zone. Seed sensor 160 is preferably disposed in an upper portion of the seed drop tube 112 to detect seed 158 traveling through the seed drop tube 112. Generally, in operation, the seed 158 can be passing by the seed sensor 160 for such a brief moment (e.g., 5-15 milliseconds) that sampling rates are generally much higher to provide the precision needed to sense multiple detections of the same seed 158. Higher detection/sampling rates can also help eliminate false detections from debris or other materials that might enter the seed drop tube 112. Higher detection/sampling rates can allow the process of actuating and deactuating the seed-applied substance valve 136 to occur within the finite window of time the seed 158 is passing through the seed-applied substance discharge path 140. Similarly, placement of the microprocessor 144 at the location of valve 136 can allow for control signals to be delivered to the valve 136 in milliseconds. In this manner, seed treatment commands corresponding to a zone being traversed or an approaching zone of a seed treatment or other field map can be delivered in advance from the main controller 142 to the microprocessor 144 to allow for the necessary data exchange to occur within a finite window. The present disclosure contemplates, in a different configuration, the placement of one or more seed sensors 160 outside of the seed drop tube 112 for providing seed detection. In some configurations, after a first detection reading for a seed 158 is acquired by the seed sensor 160, the main controller 142 and/or microprocessor 144 can be configured to ignore subsequent seed detection readings during sensor sampling of the seed travel path 159. For example, the main controller 142 and/or microprocessor 144 can be configured, in at least one aspect, to have a delay in seed sensor sampling triggered by the acquisition of a first seed sampled signal being detected. The delay can be adjusted to a period of time calculated to allow the entire seed to pass by the sensor's detection window to decrease the batch of signals the main controller 142 and/or microprocessor 144 process for each single seed detection. Generally, in operation, the process of seed-applied substance application can occur in such a finite window, that it is beneficial, in at least one configuration, to reduce the batch of signals processed for each seed detection.

Planter 100 can also be operably configured with a main controller 142 for controlling one or more operations of planter 100 and seed-applied substance applicator 134. The main controller 142 can be configured to include one or more printed circuit boards (PCBs) 152, one or more data storage devices 150, one or more transceivers 148, one or more buses 146, GPS hardware 168, and one or more microprocessors 144. In some configurations, a wiring harness 154 is operably connected between the main controller 142 and the seed-applied substance applicator 134, and data and/or control signals are transferred between the main controller 142 and seed-applied substance applicator 134 via wiring harness 154. In one aspect, control signals are communicated between main controller 142 and microprocessor 144 disposed within housing 129 for controlling operation of seed-applied substance applicator 134. In another configuration, data and control signals are transferred wirelessly between the main controller 142 and seed-applied substance applicator 134 and microprocessor 144. A transceiver 148 may be operably connected to microprocessor 144 at seed-applied substance applicator 134 for wirelessly receiving data and/or control signals from transceiver 148 at the main controller 142.

In operation, in accordance with at least one exemplary aspect, one or more prescriptive seed treatment or other field maps can be loaded onto the main controller 142 whereby prescriptive seed treatments are specified for one or more row units 104 for zones within the field (Step 200). Alternatively, if control signals are not available for controlling seed treatments, such as based upon one or more seed treatment or other field maps, the present disclosure contemplates that the main controller 142 and/or microprocessor 144 can track the prescriptive treatments applied to each seed 158 corresponding with the location of the planter 100 within the field provided from the GPS hardware 168. The location of the planter 100 within the field can be determined using, for example, a Global Navigation Satellite System (GNSS) (e.g., GPS hardware 168, Global Navigation Satellite System (GLONASS), Galileo, Navigation with Indian Constellation (NavIC), or BeiDou). In at least one configuration, Real-time kinematic (RTK) positioning can be used to enhance the precision of the position data derived from satellite-based positioning systems (e.g., GNSS). Location within the field can also be determined, for example, using an inertial navigation system (INS), cell tower triangulation, Wi-Fi triangulation, Bluetooth triangulation, or other location/position detection technologies. The seed-applied substance(s) 130 corresponding with the prescriptive seed treatment or other field maps can be loaded into seed-applied substance receptacle(s) 128 (Step 202).

In accordance with at least one exemplary method, taken from the methods of the present disclosure, a method for on-planter seed treatments is disclosed. In one example, such as during planting, control signals for approaching zones within the field can be sent from the main controller 142 to the microprocessor 144 at the seed-applied substance applicator 134 (Steps 204, 300). Seed 158 can be dispensed from seed meter 110 into seed drop tube 112 during planting. In at least one configuration, seed detection readings can be taken from the seed detection zone within the seed drop tube 112 at a desired or specified sampling rate (Step 302). Seed sensor 160 can be configured to detect seed 158 passing through the seed drop tube 112 during planting (Steps 20). In one aspect, a seed detection signal is processed at the microprocessor 144 for controlling seed-applied substance valve 136 (Step 304). In another aspect, the microprocessor 144 can be configured to apply a timestamp to the seed detection signal (Step 306). The microprocessor 144 can be programmed with a time delay program wherein the time delay can be calculated and controlled by the main controller 142 (Step 308). The time delay can be configured to correspond to the amount of time it takes for the seed 158 to travel from the seed sensor 160 to the seed-applied substance discharge path 140. Since seed, especially of different types, vary in shape, size, weight and do not necessarily travel a direct route, follow the same seed path, and descend at the same rate from the sensor 160 to the seed-applied substance discharge path 140, it is preferred that the time delay corresponds to a range of times for the applicable seed type to travel from the sensor 160 to the seed-applied substance discharge path 140. In at least one configuration of the present disclosure, the time delay can be generally between 75-100 milliseconds, between 25-75 milliseconds, between 50-100 milliseconds, 75-125 milliseconds, or 25-125 milliseconds. The time delay can be adjusted for different seed sensor 160 positions along the seed drop tube 112 and for other factors impacting the time from which the seed 158 passes the sensor 160 until the time at which the seed passes the discharge path 140. For example, the time delay could be adjusted lower for higher planting rates. In at least one configuration, based on a higher planting rate, the time delay could be zero or nearly zero milliseconds. In this case, seed are generally passing through the seed-applied substance discharge path 140 at a rate greater than the time it takes to actuate the valve 136 on and off, such that the valve 136 may remain on while seeds are being planted in some configurations. In one aspect, the time delay can be added to the timestamp applied to the time of seed detection (i.e., seed detection signal) for each seed 158 (Step 310). In at least one configuration, the time delay could be triggered upon receiving a seed detection signal from seed sensor 160 at the microprocessor 144 (Step 208).

During the programmable time delay, seed 158 can travel from the seed sensor 160 to the seed-applied substance discharge path 140. At the expiration of the time delay, microprocessor 144 can signal seed-applied substance valve 136 to open thereby discharging seed-applied substance 130 into the seed-applied substance discharge path 140 (Steps 210, 312). Seed 158 can travel through the atomized discharge cone or other shape of seed-applied substance 130 prior to descending into the furrow, which typically is then closed with the closing wheel 108 (Steps 216, 316). In one aspect, the microprocessor 144 applies a timestamp at the expiration of the time delay or at the opening of valve 136. A dispense time, in at least one exemplary range, can include ranges from 10-25 milliseconds, which are added to the timestamp (Step 308). The valve 136 can be actuated open by the microprocessor 144 during the dispense time (Steps 212, 314). At the expiration of the dispense time the microprocessor 144 can signal the valve 136 closed (Step 214). The microprocessor 144 can be configured to reset and repeat this process for each seed 158.

The seed-applied substance applicator 134 can be configured to adjust for varying planting rates and varying rates of travel from detection at the seed sensor 160 to travel through the seed-applied substance discharge path 140. The present disclosure contemplates, in at least one aspect, that external information and effects including weather, humidity, temperature, speed and direction of wind, and the like, may impact the rate of seed travel as the seed 158 descends through the seed travel path 159. In one aspect, the main controller 142 receives one or more signals from one or more sensors monitoring such external information and effects to calculate adjustments to make to the delay time and communicate those adjustments to the microprocessor 144. In some aspects, it takes anywhere from 75-100 milliseconds from the time of seed detection until the seed 158 has passed into or completely through the seed-applied substance discharge path 140. The time can vary depending on the type of seed and planting speed. The time delay for seed-applied substance applicator 134 can be adjusted in the case where planting rates exceed 75 milliseconds between seeds being dispensed into the seed drop tube 112 from the seed meter 110. In some instances, the time delay may be zero milliseconds or nearly zero milliseconds. In some of such instances, the microprocessor 144 can signal the valve 136 to open and remain open during planting, unless the seed 158 passing through the seed-applied substance discharge path 140 is not supposed to be treated based on the prescriptive seed treatment or other field map instructions received from the main controller 142.

The present disclosure contemplates in at least one aspect a plurality of seed-applied substance applicators 134 being disposed at the seed drop tube 112. In some preferred instances, one or more seed-applied substance applicators 134 can be plumbed to receive a different types, combinations or volumes of seed-applied substances 130. In some configurations, some seed-applied substance applicators 134 can have multiple nozzles 138 and/or multiple valves 136. Each seed-applied substance applicator 134, whether independently or in a set of multiple seed-applied substance applicators 134, can be configured having a single nozzle 138 and single valve 136. In some configurations, each row unit 104 could have multiple seed-applied substance applicators 134. In at least one such aspect, each row unit 104 could include a plurality of seed-applied substance applicators 134 for discharging different types, combinations or volumes of seed-applied substances 130, which could be determined in accordance with instructions from the main controller 142 provided to each microprocessor 144 or seed-applied substance valve(s) 136 of each seed-applied substance applicator 134. In some configurations, those instructions could be based on one or more prescriptive seed treatment or other field maps loaded unto the main controller 142. In another configuration, the main controller 142 could calculate a seed treatment regimen as the planter is approaching one or more zones within a field. The main controller 142 can be configured to monitor and base calculations, at least in part, on sensor readings taken in or around the field and/or sensor readings delivered by wired connection and/or wireless communication using transceiver 148. The present disclosure also contemplates that the calculation can be based, in part, on a type of seed-applied substance 130. In at least one configuration, a series of seed-applied substance applicators 134 can be disposed between opening discs 106 and closing wheels 108 of each row unit 104. In another configuration, housing 129 can include a plurality of seed-applied substance valves 136 each plumbed to a plurality of seed-applied substance receptacles 128 each preferably having different types, combinations or volumes of seed-applied substances 130. One or more of such seed-applied substance valves 136 can include a solenoid 139 for operating the valve 136 with an electrical charge. Each seed-applied substance valve 136 could also be wired to a single microprocessor 144 for controlling operation of each seed-applied substance valve 136 independently. By way of example, housing 129 at each row unit 104 could include valve one (V1), valve two (V2), valve three (V3), and valve four (V4) operably wired to a microprocessor 144. Prescriptive seed treatments instructions can be sent from the main controller 142 to the microprocessor 144 for a set of prescriptive treatments to be applied to seed 158 for the approaching zone(s) within the field. Valves (V1 and/or/no V2 and/or/no V3 and/or/no V4), or in some instance no valves (V1-V4), are actuated in a manner corresponding with the prescriptive seed treatment or other field map and the instructions provided to the microprocessor 144. The description of a certain number of valves 136 operably disposed within in a housing 129 for applying a variety of seed-applied substances 130 is presented for purposes of illustration only. The present disclosure contemplates the configuration of any number of valves 136 and nozzles 138 in a myriad of arrangements to meet a desired prescriptive seed treatment regimen. For example, in other configurations, more than four valves 136 could be used.

The disclosure is not to be limited to the particular aspects described herein. In particular, the disclosure contemplates numerous variations in methods and systems for on-planter seed treatments. The foregoing description has been presented for purposes of illustration and description. It is not intended to be an exhaustive list or limit any of the disclosure to the precise forms disclosed. It is contemplated that other alternatives or exemplary aspects are considered included in the disclosure. The description is merely examples of embodiments, processes, or methods of the disclosure. It is understood that any other modifications, substitutions, and/or additions can be made, which are within the intended spirit and scope of the disclosure.

What is claimed is:

1. A method for on-planter seed treatments, comprising:
providing a planter having a seed drop tube, a seed drop tube outlet, a seed, a seed-applied substance receptacle, and a seed-applied substance applicator having a discharge path;
loading a seed-applied substance in the seed-applied substance receptacle;
introducing the seed-applied substance at the seed-applied substance applicator;
discharging the seed-applied substance from the seed-applied substance applicator into the discharge path oriented to cover at least the portion of the seed travel path at the seed drop tube;
combining the seed from the seed drop tube with the seed-applied substance from the seed-applied substance applicator within the discharge path; and
planting the seed having on it the seed-applied substance.

2. The method of claim 1, wherein the planting step occurs immediately after the seed exits the discharge path.

3. The method of claim 1, wherein the seed-applied substance occupies the discharge path at least when the seed is within the discharge path.

4. The method of claim 1, wherein the seed-applied substance applicator is angled generally toward the seed drop tube outlet.

5. The method of claim 1, wherein the discharge path is conical in shape.

6. The method of claim 1, wherein the discharge path comprises a fan shaped pattern.

7. The method of claim 1, wherein the discharging step comprises atomizing the seed-applied substance.

8. The method of claim 1, wherein the discharge path is oriented in the direction of the seed drop tube at the seed drop tube outlet.

9. A microscale application system for on-planter seed treatments, comprising:
a planter having a plurality of row units, each row unit having a seed drop tube for planting a seed in the ground;
a seed-applied substance receptacle configured to house a seed-applied substance;
a seed-applied substance applicator disposed at the seed drop tube, the seed-applied substance applicator having a microscale nozzle configured to discharge a microscale quantity of the seed-applied substance into a discharge path;
a flow path configured between the seed-applied substance receptacle and the seed-applied substance applicator; and
a controller connected to the seed-applied substance applicator for controlling the discharge of the seed-applied substance into the discharge path.

10. The system of claim 9, further comprising:
a sensor disposed at the seed drop tube, the sensor operably connected to the controller for detecting the seed.

11. The system of claim 9, further comprising:
a controller operated microvalve disposed in the flow path.

12. The system of claim 9, wherein the microscale nozzle comprises an orifice diameter between 0.025 and 0.075 inches.

13. The system of claim 9, wherein the nozzle comprises an atomizing nozzle with an air input configured to receive air having a pressure at or less than 1 bar.

14. The system of claim 9, wherein the seed-applied substance has a viscosity range generally between 1-20 centipoise.

15. A method for on-planter seed treatments, comprising:
providing a planter having a plurality of row units, each row unit having a seed drop tube with a seed drop tube outlet for planting a seed in the ground, a seed-applied substance receptacle, a seed-applied substance applicator having a seed-applied substance nozzle for discharging the seed-applied substance, a discharge path for the seed-applied substance, and a controller;
singulating the seed;
selecting the seed-applied substance based on one or more conditions;
communicating the selected seed-applied substance from the seed-applied substance receptacle to the seed-applied substance nozzle; and
discharging the seed-applied substance into the discharge path, wherein the discharge path is disposed at the seed drop tube and the seed-applied substance occupies the discharge path at least when the singulated seed is within the discharge path.

16. The method of claim 15, further comprising:
keeping a valve for the seed-applied substance applicator open when seeds that are to receive the seed-applied substance are being planted.

17. The method of claim 15, further comprising:
opening a valve of the seed-applied substance applicator associated with the selected seed-applied substance, wherein opening the valve is based at least in part on a sensor reading taken by the controller.

18. The method of claim 15, further comprising:
opening a valve of the seed-applied substance applicator based on a time-delay triggered by the controller.

19. The method of claim 15, further comprising:
a plurality of row units have opposing soil openers and closers; and
wherein the seed-applied substance nozzle is protectively disposed between the opposing soil openers and closers.

20. The method of claims 15, further comprising:
oscillating opening and closing of a valve for the seed-applied substance applicator based on speed of travel of the planter in the field.
